(19) United States
(12) Patent Application Publication
(10) Pub. No.: US 2009/0308072 A1
(43) Pub. Date: Dec. 17, 2009

(54) Solar Energy Conversion Using Brayton Cycle System

(76) Inventor: Thomas P. Kay, Woodstock, NY (US)

Correspondence Address: LEVINE & MANDELBAUM, 222 Bloomingdale Road, Suite 203, WHITE PLAINS, NY, 10605, US

(21) Appl. No.: 12/481,656

(22) Filed: Jun. 10, 2009

Related U.S. Application Data
(60) Provisional application No. 61/060,594, filed on Jun. 11, 2008.

(51) Int. Cl. F03G 6/04; F02C 1/05; F02C 1/10

(52) U.S. Cl. 60/641.8; 60/650; 60/682

(57) ABSTRACT

A modified Brayton Cycle Engine employs solar radiation to heat a metal hydride material in a storage unit. Hydrogen driven from the metal hydride material is recombined with the material at a controlled rate in an exothermic reaction for heating a compressible Brayton working fluid for driving a turbine to which an electric generator is coupled for converting solar radiation to electricity. A compressor, also coupled to the turbine, compresses the Brayton working fluid before it is heated by the solar radiation. Heat from a solar MHD generator may also be used to heat the Brayton working fluid.

### BACKGROUND OF THE INVENTION

This invention relates to conversion of solar energy to electrical energy, and more particularly to such conversion using a Brayton cycle system.

A Brayton cycle engine traditionally includes three basic components, namely, a compressor, a combustor, and a turbine, the compressor and the turbine being mounted on the same shaft. Air compressed by the compressor is mixed with fuel and burned in the combustor. Hot gas from the combustor drives the turbine which in turn operates the compressor. Excess energy not needed to rotate the compressor is available to drive a generator or alternator so as to create electrical energy.

### SUMMARY OF THE INVENTION

According to the present invention, the combustor is eliminated, and solar energy from a collector is transmitted to the working fluid of the Brayton cycle engine so as to heat the fluid at a point upstream of the turbine. The invention also contemplates an arrangement in which solar radiation is used to heat the working fluid of a magnetohydrodynamic (MHD) energy conversion device, and heat from the MHD working fluid transmitted to the working fluid of the Brayton cycle system. Additionally, the invention contemplates employment of a metal-hydride thermal storage system for storing energy during periods of sunlight, the stored energy being available for use at night or when full sunlight is not present, to heat the working fluid of the Brayton cycle system.

### DESCRIPTION OF THE DRAWINGS

The invention will be described in more detail with reference to the accompanying drawings, in which:

FIG. 1 is a schematic diagram of a solar energy conversion arrangement using a Brayton cycle system;

FIG. 2 is a schematic diagram similar to FIG. 1, illustrating a system incorporating an MHD energy conversion device; and

FIG. 3 is a schematic diagram similar to FIG. 1, illustrating a system incorporating a metal-hydride thermal storage system.

### DESCRIPTION OF THE PREFERRED EMBODIMENT

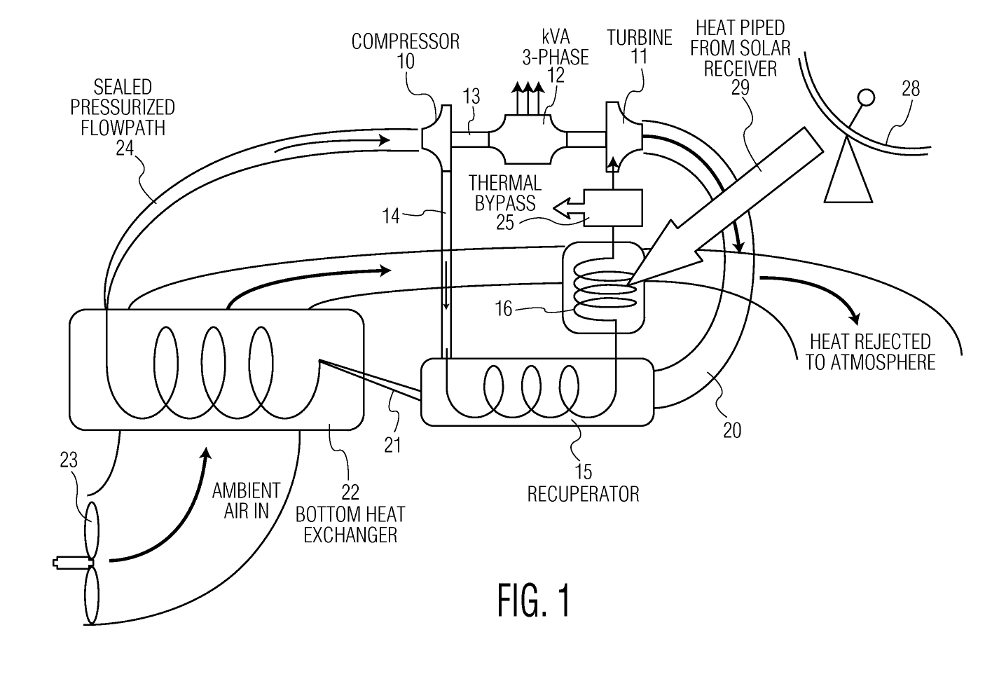

Referring to FIG. 1, a Brayton cycle engine according to the present invention includes a compressor 10 and a turbine 11 in circuit with a heat exchanger, or recuperator 15 and a heater 16. An electrical generator or alternator 12 is also provided, and preferably, the compressor, turbine, and alternator are all mounted on a single shaft 13.

Compressed working fluid leaving compressor 10 is ducted by conduit 14 to recuperator 15 from which the working fluid is further ducted to heater 16, from which point the compressed and heated working fluid flows to the turbine 11 to drive the latter. Rotation of turbine 11 serves, via shaft 13, to drive compressor 10 as well as alternator 12. The alternator may be one which produces three-phase, alternating electric current. The Brayton working fluid is preferably a gas, or mixture of gases, calculated to optimize operation of the turbine. Among the gases suitable for the purpose are argon, carbon dioxide, nitrogen, helium, xenon, and krypton.

The reduced temperature, but still hot, Brayton working fluid leaving turbine 11 flows through conduit 20 to recuperator 15, wherein it serves to pre-heat the compressed working fluid flowing to the recuperator through conduit 14. The post-turbine fluid then flows from recuperator 15 through a conduit 21 to a heat exchanger 22 which also receives ambient air from a fan 23. In this way, the post-turbine working fluid is further cooled before it continues its flow through a conduit 24 back to the inlet of compressor 10. The heat picked up by ambient air from fan 23 is dispensed to the atmosphere, or possibly used to heat other components.

A thermal bypass loop 25 may be interposed between the heater 16 and turbine 11 to limit the temperature of the working fluid entering the turbine. The loop contains a relatively cool gas which is metered into the Brayton working fluid through a valve controlled by a temperature sensor, such as a thermocouple. In this way, should the working fluid reach an excessive temperature, the metered fluid mixing with it will bring the temperature of the working fluid down to an acceptable limit.

The Brayton cycle working fluid is heated in heater 16 by means of solar radiation. This may be accomplished by using a parabolic solar collector or receiver 28, or an array of such collectors, capable of concentrating the rays of the sun at the focus of the collector. Desirably, means are provided to cause the solar collector, or collectors, to move so as to track the sun as it moves across the sky. The solar heat is then transmitted from the solar collector to the Brayton cycle working fluid in heater 16. A preferred approach to transmitting the solar heat to the working fluid is to use a heat pipe, or a bundle of two or more heat pipes, such as that made by Thermal Transtech International Corporation of Taipei, Taiwan.

A heat pipe, schematically illustrated at 29, is a sealed hollow tube containing a wicking material and an evaporable liquid. For the purposes of this invention the tube is preferably of a heat resistant material, such as a ceramic or carbon fibers, and the liquid within could be a high boiling point metal such as silver or lithium. Thermal energy is very efficiently transmitted from one end of the heat pipe to the other. Therefore, a heat pipe could be arranged to pass through the wall of the heater housing or coil containing the working fluid. One end of the heat pipe can be arranged to be heated by a parabolic reflector, such as by being located at the focus of the reflector, and the other end in contact with the working fluid within the heater 16. In this way, the solar energy is used to efficiently heat the Brayton working fluid. An advantage of using a heat pipe in this way is that a heat pipe transfers heat in only one direction, i.e., from the reflector to the working fluid container. Multiple parabolic reflectors, each including a heat pipe or pipes, could be used to heat the working fluid in the heater. Some heat pipes are flexible, which may aid this arrangement, as well as in combination with sun-tracking reflectors. Since heat pipes lose efficiency as they increase in length, the shortest possible heat pipe should be used, even as short as one foot in length.

In order to increase the efficiency of heat transfer from the heat pipe to the Brayton working fluid, the end of the heat pipe contacting the fluid may be furnished with pin-fins, such as illustrated in U.S. Pat. No. 6,817,405.

In place of the parabolic solar dish collector 28, a parabolic trough solar collector could be employed. A trough solar collector is an elongated shell having a parabolic cross-sectional shape. A conduit extends along the focus of the parabolic trough, and for the sake of efficiency the conduit is encased within an evacuated glass tube. The conduit at the focus of the parabolic trough may replace the heater 16. In this case, the compressed working fluid leaving recuperator 15 flows through the conduit of the trough solar collector, wherein the working fluid is heated, the fluid then being ducted to turbine 11.

It may be desirable to provide the conduit with fins, or honeycombs or an accordion shape to work as heat trap structures to increase the temperature of the working fluid in the conduit pipe. This “heat trap” captures the solar radiation more efficiently and causes the solar radiation to be trapped inside and not be re radiated or reflected (bounced) out, therefore increasing the temperature of the working fluid. Whereas state of the art solar trough collectors currently use black selective paint or coating to increase efficiencies, at this time these black paints or selective coatings break down at high temperatures and cannot sustain the higher temperature desired in this application or configuration.

It is contemplated that a conduit could be used to guide the working fluid from the recuperator 15 to the focus of the parabolic solar collector 28 and then on to the turbine 11, thereby replacing the heater 16.

If a trough type solar collector is employed, as described above, it may be advantageous to use a Fresnel lens in conjunction with the evacuated glass or plastic tube encasing the conduit, especially where the conduit is furnished with a heat trap structure. Attaching a Frenel lens or lenses to the tube will concentrate the solar energy and thereby increase the thermal energy transmitted to the conduit. The Fresnel lens, which may be of glass or plastic, may have any of a variety of shapes to increase the efficiency of the solar receiver. One or more elongated Fresnel lenses may extend along the full length of the conduit-containing tube. Sunlight reflected by the collector trough will reach the heat-trap-carrying conduit through the lenses. The conduit could be formed with a rectangular or square cross-sectional shape, and Fresnel lenses provided on all sides.

It is desirable to provide means for adjusting the position of the trough type collector to track the movement of the sun. If a Fresnel lens system is used in conjunction with the collector, means should also be provided to adjust the position of lens or lenses so as to maintain the focal point of each lens on the conduit as the sun moves, thereby assuring that the solar heat is concentrated on the conduit throughout the period of sunlight.

It is possible that with use of a Fresnel lens configuration in conjunction with a conduit carrying a heat trap arrangement located within an evacuated transparent tube, a parabolic collector could be eliminated, because the Fresnel lens system could sufficiently elevate the temperature of the working fluid within the conduit, or provide sufficient heat to the metal-hydride thermal storage unit.

Another possibility involves use of a large quantity, even hundreds, of smaller high temperature Fresnel Lens Solar Furnace solar collectors to transmit solar energy to a metal hydride thermal storage system.

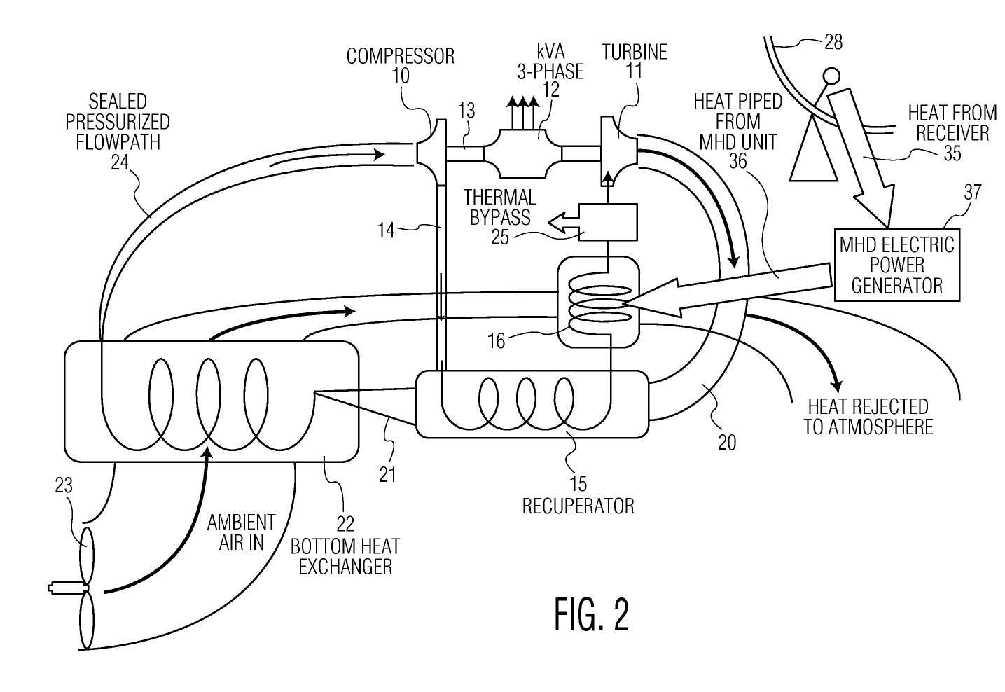

FIG. 2 illustrates a system similar to that shown in FIG. 1, except that it is used in combination with a conventional MHD solar/electrical energy conversion system 37. This type of system is known (see for example U.S. Pat. No. 4,275,318), and may include a container accommodating an MHD working fluid which is heated, such as by solar radiation captured by a solar collector 28. The solar heat may be transmitted by a heat pipe or pipes 35 to the MHD container in order to ionize the MHD working fluid in the container.

An MHD electrode system includes, as usual, a non-electrically-conductive enclosure through which the ionized working fluid flows, and a nozzle at one end for introducing the ionized plasma into the enclosure. The pressure of the working fluid is preferably sufficient to create a supersonic flow through the nozzle, since the faster the flow the more efficiently electricity is produced. Permanent magnets, which are preferably one or more Tesla, extend along the length of the enclosure to create a field perpendicular to the longitudinal direction of the enclosure. Insulation may be interposed between the magnets and the enclosure to protect the magnets from excessive heat. Electrodes are located within the enclosure in contact with the working fluid, and wires extend from the electrodes to the exterior of the enclosure for tapping electricity.

In the MHD enclosure some, but not all, of the kinetic energy of the MHD working fluid is converted into electrical energy. The gas stream leaving the MHD enclosure is still hot, and the heat of this gas can be transmitted, possibly using a heat pipe or pipes 36, to the heater 16 for heating the compressed Brayton working fluid. In this arrangement, electricity is produced both by the MHD system 37 as well by the alternator 12.

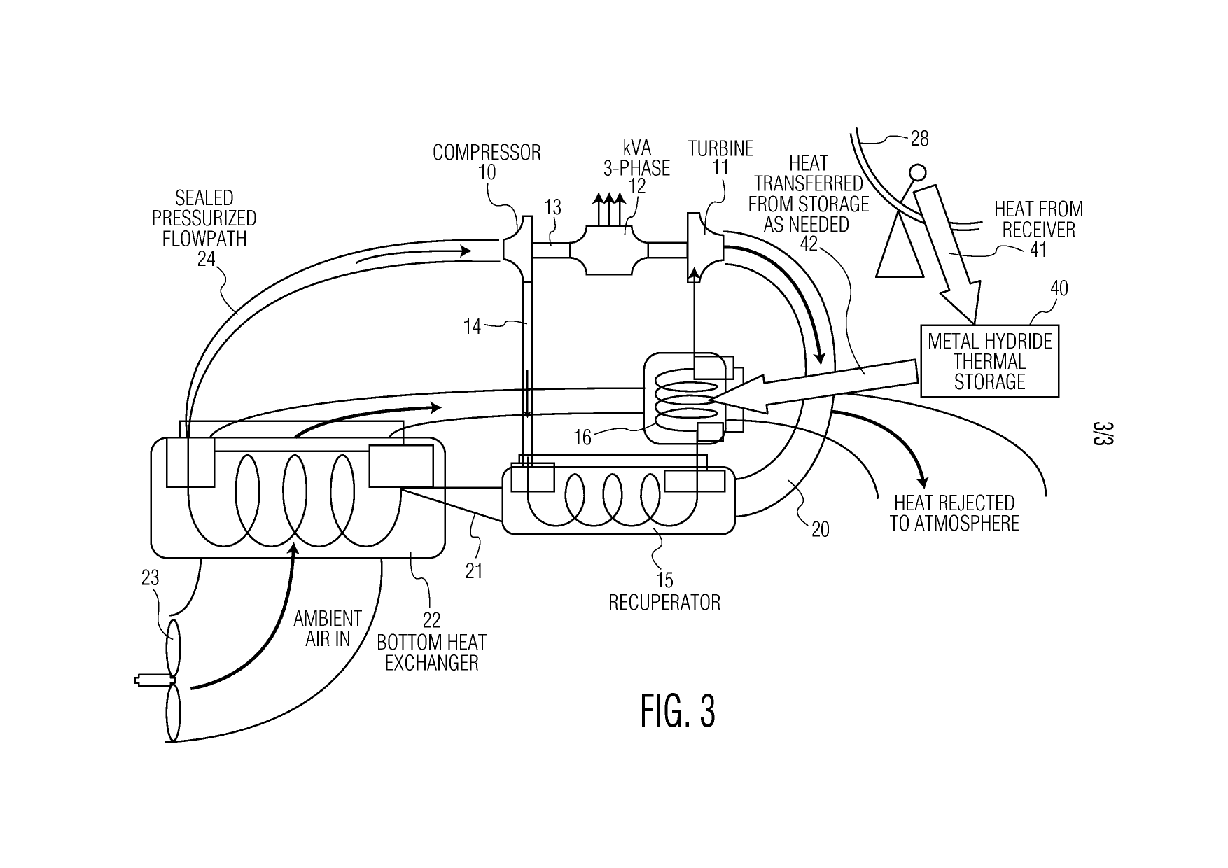

FIG. 3 illustrates a system similar to that shown in FIG. 1, except that instead of the heat of solar radiation being transmitted directly to heater 16, the solar heat is delivered to a metal-hydride thermal storage unit 40 from which it is transmitted to the heater. The solar heat may be transmitted from the collector 28, or an array of such collectors, by a heat pipe or pipes 41 to the storage unit 40, and stored heat may be released, as needed, to the heater 16 via a heat pipe or pipes 42.

When heat energy is delivered to a metal-hydride system, heating of the metal-hydride drives off the hydrogen, which is then stored at a safe location under a preferably medium pressure. If heat is needed to run the Brayton unit during hours when sunlight is not available, hydrogen is allowed to recombine with the metal in a reaction that is highly exothermic. Heat produced by the exothermic reaction is used to heat the working fluid in heater 16. A particular advangage of the metal hydrides over other thermal storage materials is that the metal hydrides permit a greater degree of control to be exercised over the rate of heat release when needed.

Examples of suitable metal hydrides include iron titanium hydride, lithium hydride, and lithium aluminum hydride. The most desirable metal hydrides will be those with high negative heats of formation per unit volume of storage. Metal-hydrogen systems are non-corrosive and they can undergo indefinite cycling with no chemical degradation. The metal hydride thermal storage system uses a controlled dissociation pressure. It is a reversible dissociation system that is regenerative.

Storage volume of the metal-hydride system will be tailored for each application with larger volumes needed in areas where stored heat for several days of operation may be needed. Smaller volumes would bridge the hours between day and night. It is believed to be advantageous to store the thermal energy from the solar collector/receiver at a constant temperature in a liquid metal hydride. A liquid metal transfer circuit could be used to carry heat from the solar receiver to the thermal storage device to melt the metal hydride. A heat exchanger in the liquid metal hydride could be used to transfer heat to the working fluid of the Brayton system. In addition to providing heat for operation of the Brayton unit, the metal hydride system can also directly heat air and water for combined heating and power systems, such as those using Stirling engines, to increase overall efficiency of these systems. With sufficient volume, a metal hydride system can store and release sufficient heat energy to provide releases of hot thermal energy for several days.

It also contemplated that a system as illustrated in FIG. 3, combining solar energy and a metal hydride storage unit, could be used to power vehicles, such as cars and trucks, vessels, trains, aircraft and spacecraft. A solar collector, preferably incorporating Fresnel lenses, may be installed on the exterior of the vehicle or the like, and that vehicle can carry an on board metal hydride thermal storage unit for storing the solar heat. Electricity generated by the system would be used to power the vehicle, etc. Additionally, heat stored in a stationary version of the system illustrated in FIG. 3 could be tapped into for “recharging” the thermal storage unit carried by the vehicle.

Another possibility is the creation of shingles, which may be interlocking, for covering the exterior of a building, comprising solar collectors incorporating Fresnel lenses for feeding solar heat to a metal hydroxide thermal storage unit.

It is believed that solar energy conversion systems as illustrated in FIGS. 1-3, and described herein, are ideally suited for use on the moon and elsewhere in the planetary system.

What is claimed is:

1. Apparatus for converting solar energy to electrical energy comprising
a rotatable shaft,
a compressor coupled to said shaft for rotation therewith,
a turbine coupled to said shaft for rotation therewith,
an electric generator coupled to said shaft,
a compressible Brayton working fluid,
a compressible Brayton working fluid heating station,
a thermal storage unit comprising a metal hydride material,
a solar receiver for receiving solar radiation for heating said metal hydride in said thermal storage unit,
said thermal storage unit being adapted to store hydrogen driven from said metal hydride material in response to the heating thereof, and to recombine said hydrogen with said metal hydride material in a controllable exothermic reaction for producing heat,
a storage-heating station conduit for transferring heat from said storage unit to said Brayton working fluid at said heating station,
a heating station-turbine conduit operatively connected between said heating station and said turbine,
a turbine-compressor conduit operatively connected between said turbine and said compressor,
a compressor-heating station conduit operatively connected between said compressor and said heating station,
said compressible Brayton working fluid having a pressure which increases at said heating station thereby propelling said Brayton working fluid through said heating station-turbine conduit to said turbine to cause rotation of said turbine, said shaft and said compressor, said heated Brayton working fluid thereafter passing from said turbine to said compressor through said turbine-compressor conduit where the pressure of said Brayton working fluid then being increased and said Brayton working fluid is propelled through said compressor-heating station conduit back past said heating station whereafter said Brayton working fluid is continuously recirculated to drive said turbine and said shaft for causing said generator to produce electrical energy.

2. Apparatus for converting solar energy to electrical energy according to claim 1 wherein said metal hydride material comprises a metal hydride selected from the group consisting of iron titanium hydride, lithium hydride, and lithium aluminum hydride.

3. Apparatus for converting solar energy to electrical energy according to claim 1 wherein said storage-heating station conduit comprises a liquid metal transfer circuit for carrying heat from said storage unit and a heat exchanger for transferring heat from a liquid in said liquid metal to said Brayton working fluid.
